(19) United States
(12) Patent Application Publication
(10) Pub. No.: US 2024/0276447 A1
(43) Pub. Date: Aug. 15, 2024

(54) APPARATUS, METHODS, AND COMPUTER PROGRAMS

(71) Applicant: Nokia Technologies Oy, Espoo (FI)

(72) Inventors: Oana-Elena BARBU, Aalborg (DK); Diomidis MICHALOPOULOS, Munich (DE); Benny VEJLGAARD, Aalborg (DK)

(21) Appl. No.: 18/564,901

(22) PCT Filed: Apr. 6, 2022
(86) PCT No.: PCT/EP2022/059079

§ 371 Date: Nov. 28, 2023

(30) Foreign Application Priority Data
Jun. 2, 2021 (FI) 20215641

(51) Int. Cl. H04W 64/00; H04B 17/318; H04W 76/14

(52) U.S. Cl. CPC H04W 64/006; H04B 17/328; H04W 76/14

(57) ABSTRACT

There is provided an apparatus, method for an apparatus, and computer program product for an apparatus for a first terminal that causes the apparatus to: receive, from a second terminal, an indication of a degree of collinearity of at least two transmission points relative to a location of the second terminal; select a subset of the at least two transmission points using the indication of a degree of collinearity; and perform a location operation using the selected subset of the at least two transmission points.

### FIELD

The present disclosure relates to apparatus, methods, and computer programs, and in particular but not exclusively to apparatus, methods and computer programs for network apparatuses.

### BACKGROUND

A communication system can be seen as a facility that enables communication sessions between two or more entities such as user terminals, access nodes and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Content may be multicast or uni-cast to communication devices.

A user can access the communication system by means of an appropriate communication device or terminal. A communication device of a user is often referred to as user equipment (UE) or user device. The communication device may access a carrier provided by an access node and transmit and/or receive communications on the carrier.

The communication system and associated devices typically operate in accordance with a required standard or specification which sets out what the various entities associated with the system are permitted to do and how that should be achieved. Communication protocols and/or parameters which shall be used for the connection are also typically defined. One example of a communications system is UTRAN (3G radio). Another example of an architecture that is known is the long-term evolution (LTE) or the Universal Mobile Telecommunications System (UMTS) radio-access technology. Another example communication system is so called 5G system that allows user equipment (UE) or user device to contact a 5G core via e.g. new radio (NR) access technology or via other access technology such as Untrusted access to 5GC or wireline access technology.

### SUMMARY

According to a first aspect, there is provided an apparatus for a first terminal, the apparatus comprising: means for receiving, from a second terminal, an indication of a degree of collinearity of at least two transmission points relative to a location of the second terminal; means for selecting a subset of the at least two transmission points using the indication of a degree of collinearity; and means for performing a location operation using the selected subset of the at least two transmission points.

The apparatus may comprise: means for receiving, from a network function, configuration information suitable for configuring reception of device-to-device signalling indicating the degree of collinearity from the second terminal at the first terminal; and means for using the configuration information to configure the first terminal to receive the indication of a degree of collinearity.

The apparatus may comprise: means for receiving an indication of a relative degree of signal quality for the at least two transmission points; and wherein the means for selecting may comprise using the indication of the relative degree of signal quality.

The indication of the relative degree of signal quality may comprise indications of respective signal qualities for the at least two transmission points.

The apparatus may comprise: means for transmitting, to a network function, a request to trigger the second terminal to transmit the indication of the relative degree of signal quality.

According to a second aspect, there is provided an apparatus for a second terminal, the apparatus comprising: means for transmitting, to a first terminal, an indication of a degree of collinearity of at least two transmission points relative to a location of the second terminal.

The apparatus may comprise: means for receiving, from a network function, configuration information suitable for configuring transmission of device-to-device signalling indicating the degree of collinearity of at least two transmission points from the second terminal to the first terminal; and means for using the configuration information to configure the second terminal to transmit the indication of the degree of collinearity.

The apparatus may comprise: means for transmitting to the first terminal an indication of a relative degree of signal quality for the at least two transmission points.

The indication of the relative degree of signal quality may comprise indications of respective signal qualities for the at least two transmission points.

According to a third aspect, there is provided an apparatus for a network function, the apparatus comprising: means for, in response to receiving a location service request for a first terminal, selecting a second terminal by: determining at least one terminal capable of both device-to-device communication with the first terminal and determining a degree of collinearity of at least two transmission points relative to the said at least one terminal; and selecting the second terminal from the determined at least one terminal; and means for signalling configuration information to at least one of the first and second terminals, the configuration information being suitable for configuring device-to-device signalling indicating a degree of collinearity of at least two transmission points relative to the second terminal from the second terminal to the first terminal.

The apparatus may comprise: means for receiving, from the first terminal, a request to trigger the second terminal to transmit the indication of the relative degree of signal quality.

According to a fourth aspect, there is provided an apparatus for a first terminal, the apparatus comprising: at least one processor; and at least one memory comprising code that, when executed by the at least one processor, causes the apparatus to: receive, from a second terminal, an indication of a degree of collinearity of at least two transmission points relative to a location of the second terminal; select a subset of the at least two transmission points using the indication of a degree of collinearity; and perform a location operation using the selected subset of the at least two transmission points.

The apparatus may be caused to: receive, from a network function, configuration information suitable for configuring reception of device-to-device signalling indicating the degree of collinearity from the second terminal at the first terminal; and use the configuration information to configure the first terminal to receive the indication of a degree of collinearity.

The apparatus may be caused to: receive an indication of a relative degree of signal quality for the at least two transmission points; and wherein the selecting may comprise using the indication of the relative degree of signal quality.

The indication of the relative degree of signal quality may comprise indications of respective signal qualities for the at least two transmission points.

The apparatus may be caused to: transmit, to a network function, a request to trigger the second terminal to transmit the indication of the relative degree of signal quality.

According to a fifth aspect, there is provided an apparatus for a second terminal, the apparatus comprising: at least one processor; and at least one memory comprising code that, when executed by the at least one processor, causes the apparatus to: transmit, to a first terminal, an indication of a degree of collinearity of at least two transmission points relative to a location of the second terminal.

The apparatus may be caused to: receive, from a network function, configuration information suitable for configuring transmission of device-to-device signalling indicating the degree of collinearity of at least two transmission points from the second terminal to the first terminal; and use the configuration information to configure the second terminal to transmit the indication of the degree of collinearity.

The apparatus may be caused to: transmit to the first terminal an indication of a relative degree of signal quality for the at least two transmission points.

The indication of the relative degree of signal quality may comprise indications of respective signal qualities for the at least two transmission points.

According to a sixth aspect, there is provided an apparatus for a network function, the apparatus comprising: at least one processor; and at least one memory comprising code that, when executed by the at least one processor, causes the apparatus to: in response to receiving a location service request for a first terminal, select a second terminal by: determining at least one terminal capable of both device-to-device communication with the first terminal and determining a degree of collinearity of at least two transmission points relative to the said at least one terminal; and selecting the second terminal from the determined at least one terminal; and signal configuration information to at least one of the first and second terminals, the configuration information being suitable for configuring device-to-device signalling indicating a degree of collinearity of at least two transmission points relative to the second terminal from the second terminal to the first terminal.

The apparatus may be caused to: receive, from the first terminal, a request to trigger the second terminal to transmit the indication of the relative degree of signal quality.

According to a seventh aspect, there is provided a method for an apparatus for a first terminal, the method comprising: receiving, from a second terminal, an indication of a degree of collinearity of at least two transmission points relative to a location of the second terminal; selecting a subset of the at least two transmission points using the indication of a degree of collinearity; and performing a location operation using the selected subset of the at least two transmission points.

The method may comprise: receiving, from a network function, configuration information suitable for configuring reception of device-to-device signalling indicating the degree of collinearity from the second terminal at the first terminal; and using the configuration information to configure the first terminal to receive the indication of a degree of collinearity.

The method may comprise: receiving an indication of a relative degree of signal quality for the at least two transmission points; and wherein the selecting may comprise using the indication of the relative degree of signal quality.

The indication of the relative degree of signal quality may comprise indications of respective signal qualities for the at least two transmission points.

The method may comprise: transmitting, to a network function, a request to trigger the second terminal to transmit the indication of the relative degree of signal quality.

According to an eighth aspect, there is provided a method for an apparatus for a second terminal, the method comprising: transmitting, to a first terminal, an indication of a degree of collinearity of at least two transmission points relative to a location of the second terminal.

The method may comprise: receiving, from a network function, configuration information suitable for configuring transmission of device-to-device signalling indicating the degree of collinearity of at least two transmission points from the second terminal to the first terminal; and using the configuration information to configure the second terminal to transmit the indication of the degree of collinearity.

The method may comprise: transmitting to the first terminal an indication of a relative degree of signal quality for the at least two transmission points.

The indication of the relative degree of signal quality may comprise indications of respective signal qualities for the at least two transmission points.

According to a ninth aspect, there is provided a method for an apparatus for a network function, the method comprising: in response to receiving a location service request for a first terminal, selecting a second terminal by: determining at least one terminal capable of both device-to-device communication with the first terminal and determining a degree of collinearity of at least two transmission points relative to the said at least one terminal; and selecting the second terminal from the determined at least one terminal; and signalling configuration information to at least one of the first and second terminals, the configuration information being suitable for configuring device-to-device signalling indicating a degree of collinearity of at least two transmission points relative to the second terminal from the second terminal to the first terminal.

The method may comprise: receiving, from the first terminal, a request to trigger the second terminal to transmit the indication of the relative degree of signal quality.

According to a tenth aspect, there is provided an apparatus for a first terminal, the apparatus comprising: receiving circuitry for receiving, from a second terminal, an indication of a degree of collinearity of at least two transmission points relative to a location of the second terminal; selecting circuitry for selecting a subset of the at least two transmission points using the indication of a degree of collinearity; and performing circuitry for performing a location operation using the selected subset of the at least two transmission points.

The apparatus may comprise: receiving circuitry for receiving, from a network function, configuration information suitable for configuring reception of device-to-device signalling indicating the degree of collinearity from the second terminal at the first terminal; and using circuitry for using the configuration information to configure the first terminal to receive the indication of a degree of collinearity.

The apparatus may comprise: receiving circuitry for receiving an indication of a relative degree of signal quality for the at least two transmission points; and wherein the selecting circuitry may comprise using the indication of the relative degree of signal quality.

The indication of the relative degree of signal quality may comprise indications of respective signal qualities for the at least two transmission points.

The apparatus may comprise: transmitting circuitry for transmitting, to a network function, a request to trigger the second terminal to transmit the indication of the relative degree of signal quality.

According to an eleventh aspect, there is provided an apparatus for a second terminal, the apparatus comprising: transmitting circuitry for transmitting, to a first terminal, an indication of a degree of collinearity of at least two transmission points relative to a location of the second terminal.

The apparatus may comprise: receiving circuitry for receiving, from a network function, configuration information suitable for configuring transmission of device-to-device signalling indicating the degree of collinearity of at least two transmission points from the second terminal to the first terminal; and using circuitry for using the configuration information to configure the second terminal to transmit the indication of the degree of collinearity.

The apparatus may comprise: transmitting circuitry for transmitting to the first terminal an indication of a relative degree of signal quality for the at least two transmission points.

The indication of the relative degree of signal quality may comprise indications of respective signal qualities for the at least two transmission points.

According to a twelfth aspect, there is provided an apparatus for a network function, the apparatus comprising: selecting circuitry for, in response to receiving a location service request for a first terminal, selecting a second terminal by: determining at least one terminal capable of both device-to-device communication with the first terminal and determining a degree of collinearity of at least two transmission points relative to the said at least one terminal; and selecting the second terminal from the determined at least one terminal; and signalling circuitry for signalling configuration information to at least one of the first and second terminals, the configuration information being suitable for configuring device-to-device signalling indicating a degree of collinearity of at least two transmission points relative to the second terminal from the second terminal to the first terminal.

The apparatus may comprise: receiving circuitry for receiving, from the first terminal, a request to trigger the second terminal to transmit the indication of the relative degree of signal quality.

According to a thirteenth aspect, there is provided non-transitory computer readable medium comprising program instructions for causing an apparatus for a first terminal to perform at least the following: receive, from a second terminal, an indication of a degree of collinearity of at least two transmission points relative to a location of the second terminal; select a subset of the at least two transmission points using the indication of a degree of collinearity; and perform a location operation using the selected subset of the at least two transmission points.

The apparatus may be caused to: receive, from a network function, configuration information suitable for configuring reception of device-to-device signalling indicating the degree of collinearity from the second terminal at the first terminal; and use the configuration information to configure the first terminal to receive the indication of a degree of collinearity.

The apparatus may be caused to: receive an indication of a relative degree of signal quality for the at least two transmission points; and wherein the selecting may comprise using the indication of the relative degree of signal quality.

The indication of the relative degree of signal quality may comprise indications of respective signal qualities for the at least two transmission points.

The apparatus may be caused to: transmit, to a network function, a request to trigger the second terminal to transmit the indication of the relative degree of signal quality.

According to a fourteenth aspect, there is provided non-transitory computer readable medium comprising program instructions for causing an apparatus for a second terminal to perform at least the following: transmit, to a first terminal, an indication of a degree of collinearity of at least two transmission points relative to a location of the second terminal.

The apparatus may be caused to: receive, from a network function, configuration information suitable for configuring transmission of device-to-device signalling indicating the degree of collinearity of at least two transmission points from the second terminal to the first terminal; and use the configuration information to configure the second terminal to transmit the indication of the degree of collinearity.

The apparatus may be caused to: transmit to the first terminal an indication of a relative degree of signal quality for the at least two transmission points.

The indication of the relative degree of signal quality may comprise indications of respective signal qualities for the at least two transmission points.

According to a fifteenth aspect, there is provided non-transitory computer readable medium comprising program instructions for causing an apparatus for a network function to perform at least the following: in response to receiving a location service request for a first terminal, select a second terminal by: determining at least one terminal capable of both device-to-device communication with the first terminal and determining a degree of collinearity of at least two transmission points relative to the said at least one terminal; and selecting the second terminal from the determined at least one terminal; and signal configuration information to at least one of the first and second terminals, the configuration information being suitable for configuring device-to-device signalling indicating a degree of collinearity of at least two transmission points relative to the second terminal from the second terminal to the first terminal.

The apparatus may be caused to: receive, from the first terminal, a request to trigger the second terminal to transmit the indication of the relative degree of signal quality.

According to a sixteenth aspect, there is provided a computer program comprising program instructions for causing a computer to perform any method as described above.

According to a seventeenth aspect, there is provided a computer program product stored on a medium that may cause an apparatus to perform any method as described herein.

According to an eighteenth aspect, there is provided an electronic device that may comprise apparatus as described herein.

According to a nineteenth aspect, there is provided a chipset that may comprise an apparatus as described herein.

### BRIEF DESCRIPTION OF FIGURES

Examples will now be described, by way of example only, with reference to the accompanying Figures in which:

FIG. 1 shows a schematic representation of a 5G system;

FIG. 2 shows a schematic representation of a network apparatus;

FIG. 3 shows a schematic representation of a user equipment;

FIG. 4 shows a schematic representation of a non-volatile memory medium storing instructions which when executed by a processor allow a processor to perform one or more of the steps of the methods of some examples;

FIG. 5 shows a schematic representation of a 5G system;

FIGS. 6 and 7 are schematic representations of terminals, such as user equipment, transmit receive points (such as access points), and their relative physical location;

FIG. 8 is an example signal diagram showing potential signalling between apparatus described herein; and

FIGS. 9 to 11 are flow charts illustrating potential operations that may be performed by apparatus described herein.

### DETAILED DESCRIPTION

In the following, certain aspects are explained with reference to mobile communication devices capable of communication via a wireless cellular system and mobile communication systems serving such mobile communication devices. For brevity and clarity, the following describes such aspects with reference to a 5G wireless communication system. However, it is understood that such aspects are not limited to 5G wireless communication systems, and may, for example, be applied to other wireless communication systems with analogous components (for example, current 6G proposals). In the following, 3GPP refers to a group of organizations that develop and release different standardized communication protocols. 3GPP is currently developing and publishing documents related to Release 16, relating to 5G technology, with Release 17 currently being scheduled for 2022.

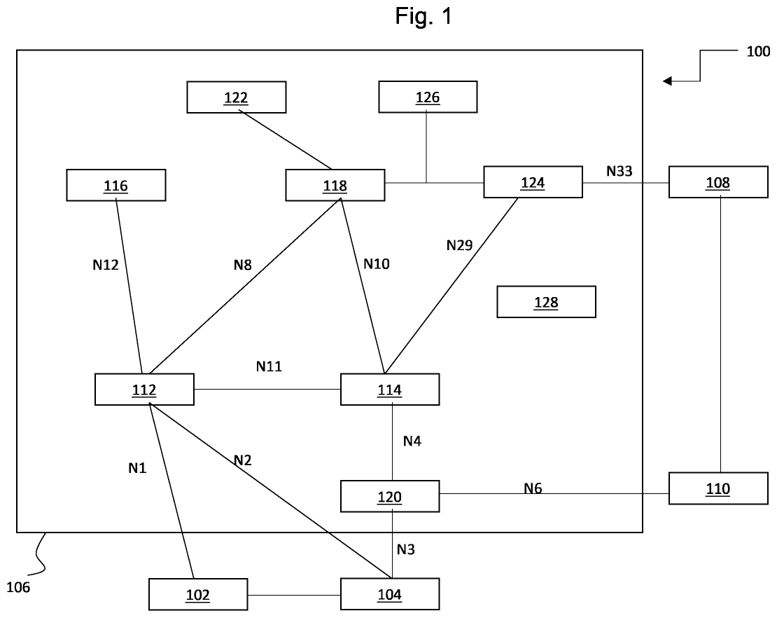

Before explaining in detail the exemplifying embodiments, certain general principles of a 5G wireless communication system are briefly explained with reference to FIG. 1.

FIG. 1 shows a schematic representation of a 5G system (5GS) 100. The 5GS may comprise a user equipment (UE) 102 (which may also be referred to as a communication device or a terminal), a 5G access network (AN) (which may be a 5G Radio Access Network (RAN) or any other type of 5G AN such as a Non-3GPP Interworking Function (N3IWF)/a Trusted Non3GPP Gateway Function (TNGF) for Untrusted/Trusted Non-3GPP access or Wireline Access Gateway Function (W-AGF) for Wireline access) 104, a 5G core (5GC) 106, one or more application functions (AF) 108 and one or more data networks (DN) 110.

The 5G RAN may comprise one or more gNodeB (gNB) distributed unit functions connected to one or more gNodeB (gNB) unit functions. The RAN may comprise one or more access nodes. It is understood that although the example network element is shown as a single apparatus, that the functions of the network element may be split amongst several distinct apparatuses.

The 5GC 106 may comprise one or more network functions, including one or more Access Management Functions (AMF) 112, one or more Session Management Functions (SMF) 114, one or more authentication server functions (AUSF) 116, one or more unified data management (UDM) functions 118, one or more user plane functions (UPF) 120, one or more unified data repository (UDR) functions 122, one or more network repository functions (NRF) 128, and/or one or more network exposure functions (NEF) 124. Although the NRF 128 is not depicted with its interfaces, it is understood that this is for clarity reasons and that NRF 128 may have a plurality of interfaces with other network functions. It is understood that although the example network functions are respectively shown as a single apparatus, that the functions of each network function may be split amongst several distinct apparatuses.

The NRF performs multiple functions for the 5GC 106. For example, the NRF is configured to maintain a network function (NF) profile of available NF instances and their supported services, where an NF instance identifier represents an identifier identifying a particular NF/NF instance. The NF instance identifier is provided by the NF service consumer (i.e. a network function that is requesting a service from another entity, such as an NF service producer), and is globally unique inside the Public landline Mobile Network of the NRF in which the NF is registered. The NRF is also configured to allow other NF instances to subscribe to, and get notified about, the registration in NRF of new NF instances of a given type. The NRF is further configured to support service discovery functions by receiving NF Discovery Requests from NF instances, and provide information in respect of available NF instances fulfilling certain criteria (e.g., supporting a given service) in response to those NF Discovery Requests.

The 5GC 106 also comprises a network data analytics function (NWDAF) 126. The NWDAF is responsible for providing network analytics information upon request from one or more network functions or apparatus within the network. Network functions can also subscribe to the NWDAF 126 to receive information therefrom. Accordingly, the NWDAF 126 is also configured to receive and store network information from one or more network functions or apparatus within the network. The data collection by the NWDAF 126 may be performed based on at least one subscription to the events provided by the at least one network function.

The 5G standards introduced a new architectural concept into 3GPP communication networks called the Service Based Architecture (SBA). Using this architecture, Network Functions (NFs) can be virtualized and provide their services, using defined protocols and interfaces to other network functions or external parties' “verticals” (e.g. industrial application such as transport, media, and manufacturing). The interfaces are referred to as service-based interfaces (SBI), and may comprise REST API-based interfaces. The protocols for communication between the network elements may be, for example, the common HTTP/2 Internet protocol.

3GPP refers to a group of organizations that develop and release different standardized communication protocols. They are currently developing and publishing documents related to Release 16, relating to 5G technology, with Release 17 currently being scheduled for 2022.

3GPP Release 17 (Rel-17) groups are currently aiming to develop mechanisms for improving positioning accuracy relative to currently used techniques.

For example, RP-202900 is a study item published by 3GPP that lists several specific objectives for Rel-17. These objectives include specifying methods, measurements, signalling and procedures for improving the positioning accuracy of Release 16 (Rel-16) New Radio positioning methods by mitigating UE receive/transmit and/or gNB receive/transmit timing delays. This includes those timing delays related to Rel-16 radio access network downlink, uplink, and downlink and uplink positioning methods, and covers both UE-based and UE-assisted positioning solutions.

These objectives further include specifying the procedure, measurements, reporting and signalling for improving the accuracy of the radio access network uplink angle of arrival for network-based positioning solutions, and downlink angle-of-departure for UE-based and network-based (including UE-assisted) positioning solutions.

As another example, RP-201272 is a 3GPP study item that includes several objectives for positioning use cases, including requirements and scenarios for a UE in each of an in-coverage scenario, a partial coverage scenario, and an out-of-coverage scenario with respect to network coverage currently defined. These objectives included both identifying the positioning use requirements and requirements for prioritizing V2X (“Vehicle to anything”) and public safety use cases based on existing 3GPP work, and identifying the potential deployment and operation scenarios.

The current 3GPP positioning protocol mandates the UE to report back timing and/or angular measurements for all detectable beams of all detectable transmit-receive points (TRP) upon request from a network entity, such as a request from the location management function (LMF). In the present context, the term TRP is used to indicate an access point to a communication network, such as a gNB, a femto node, etc. By default, the UE treats each positioning request identically. The UE may listen for and measure beamed downlink positioning reference signals (PRS) respectively transmitted by TRPs during designated time windows.

The UE makes various attempts to detect the TRPs indicated by the network, and to estimate a value for at least one geodetic-related parameter, such as, for example, the time and/or angle of arrival (TOA/AOA) of the line of sight (LOS) for each beam of each detected positioning signal. A typical scenario comprises a request from the network to measure N TRPs (e.g. N>24 TRPs), each with K beams (e.g. K≥8 beams), which means that the UE often detects and measures more than 192 signals per positioning request (N*K>192). The number of signals to be detected and measured per positioning request is exacerbated at higher carrier frequencies, as the number of beams per TRP (K) increases. This leads to a higher computational load on the UE, which consumes both computational and battery resources.

It therefore becomes therefore impractical for the network to ask a UE for TRP measurements (which may comprise thousands of beamed PRS), and for the UE to perform the measurements at each request, without a prior evaluation of whether the measurement is useful.

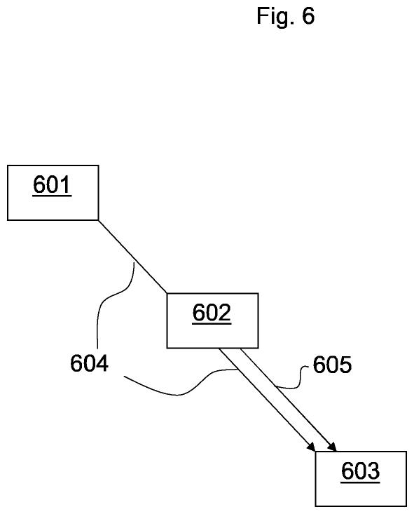

FIG. 6 illustrates an example of when a TRP measurement may not be usefully made, with the TRP being labelled as an access point.

FIG. 6 illustrates a first access point/gNB 601, a second access point/gNB 602, and a UE 603. The UE 601 may detect a signal 604 from the first access point 601 along a first direction, and may also detect a signal 605 from the second access point 602 along the first direction. This is known as collinearity. One method of indicating degree of collinearity is by indicating a geometric dilution of precision (GDOP). For clarity, the following will refer to degree of collinearity as GDOP, although it is understood that any metric that can be used for indicating a degree of collinearity between signals originating from different TRPs may be used in place of GDOP.

In the example of FIG. 6, as the first access point 601, the second access point 602 and the UE 603 are collinear (or approximately collinear, with the degree of how similar the collinear values may be to be considered as similar being predefined by a collinearity threshold value), the PRS of both the first and the second access points are characterised by the same AoA (or by a similar AoA, with the degree of how similar the AoA values may be to be considered as similar being predefined by an AoA threshold value) and the TOA of one access point is shifted from the TOA of the other access point by a known quantity (given by the known distance between the access points. This means that the UE can measure the PRS of only one of the two access points, while the other PRS of the other access point may be inferred from the measured values. In other words, the time of arrival of a PRS from the first access point to the UE 603 is given by the time of arrival of the PRS signal from the first access point 601 to the second access point 602 and the time of arrival of the time of arrival of the PRS signal from the second access point 602 to the UE 603, and the angle of arrival of the PRS signal from first access point 601 to the UE 603 is approximately equal to the angle of arrival of the PRS signal from the second access point to the UE 603.

Therefore, if the network has an indication of the degree of collinearity, e.g. the GDOP, among the 3 entities, the network could request that the UE measures the PRS from only one of the collinear access points instead of both. Extrapolating to the case where there are a lot of access points (say N>>1) simultaneously collinear with each other and the UE, the UE may measure the PRS of only one access point out of N access points. This reduces both the computational burden and also the signaling overhead associated with reporting back a large set of otherwise linearly dependent measurements.

It would therefore be useful to enable a UE to learn and/or estimate the GDOP. Implementing such a method allows for a reduced measurement request to the UE, and subsequently a reduced computation cost of performing these measurements by the UE.

There are some existing methods by which a UE performs positioning-related measurements.

Some of these existing methods relate to a UE reporting to the network the relative angle of arrival from which they receive different TRPs. In such systems, the UE does not perform any calculation of GDOP between the TRPs, but instead reports a value (such as relative angle of arrival) to the network, which then uses that reported value to estimate the GDOP.

Some of these existing methods relate to an LMF that employs a machine learning (ML) framework for collinearity detection for a given 3D location at the network side based on the collected UE measurements. The network then creates a set of reduced assistance data message, which is sent to the UE to minimize the measurement report it sends to the network.

In contrast to previously discussed systems, the following relates to using device-to-device (e.g. sidelink (SL)) transmission of assistance data for GDOP calculation. That is, the following discloses utilizing neighbour UEs to assist a target/receiving UE by means of a new assistance data message (referred to in the following as GDOP assistance packet) that is transmitted directly between UEs (i.e. without the GDOP assistance packet traversing the communication network/access points). The contents of the GDOP assistance packet may be evaluated by the receiving UE with respect to the assistance it can offer for estimating the GDOP.

The following discusses aspects that may be implemented in such a system.

As an initial step, active UEs may signal to the network (e.g. to an LMF) their capability for GDOP computation. This may be useful, for example, when not all UEs are capable of extracting the GDOP and/or metrics leading to GDOP, such as relative AOA between TRP pairs. This capability may be explicitly signalled. The signalling may be performed, for example, using a flag sent in RRC-connected mode. This signalling may be performed, for example, by comprising the capability in the UE capability information registered for the UE in the core network, which may be retrieved by other network entities, such as the LMF.

Taking the LMF as an example, the LMF may subsequently receive a location service (LCS) request for a target UE. When the LMF decides on a downlink positioning method, then the LMF may additionally check whether the target UE needs help to acquire GDOP, e.g. the UE may not have the capability, or the time to do so. A UE may not have time to acquire GDOP when the UE has tight latency requirement that do not allow for additional processing. As another example, in UE-based positioning, once an internal UE application instigates a LCS request, the UE itself may check to determine whether it needs help to acquire GDOP.

When the LMF determines that the target UE needs GDOP-assistance, the LMF may trigger one or more neighbor UEs that are GDOP-capable to initiate a device-to-device (e.g. sidelink) transmission of a GDOP assistance packet (GDOP assistance packet). It is understood that this is merely one example, and that, as another example, the UE may request assistance from the network to trigger neighbor UEs to initiate SL broadcast transmission of GDOP assistance packet.

The GDOP assistance packet from the neighbour UE(s) may be broadcast, multicast, or unicast. To that end, the LMF may configure the neighbor UE(s) for device-to-device transmission of a GDOP assistance packet.

The GDOP assistance packet may comprise a header portion and a data portion.

The header portion may have a length of K symbols, such as K orthogonal frequency division multiplex (OFDM) symbols. The K symbols may all be occupied by a UE-specific reference signal. It is understood that although the present example considers orthogonal frequency division multiple access waveforms, the presently described techniques may be applied in respect of other waveforms. For example, the presently described techniques may similarly be applied to single carrier frequency division multiple access.

The data portion may have a length of M symbols, such as M OFDM symbols. The M symbols may be configured to transfer GDOP values between TRP pairs detected at neighbour UE.

For example, the data packet may encode the following information:

TABLE 1
Example TRP information contained in a GDOP assistance packet

| GDOP | | Signal to Noise Ratio TRP |
|---|---|---|
| value | TRP pair (j, k) | pair (j, k) |
| high | (id1, idN) | (snr1, snrN) |
| . . . | . . . | . . . |
| low | (idL, id3) | (snrL, snr3) |

The LMF may also inform the target UE about the GDOP assistance packet configuration.

Once a neighbour UE has transmitted a GDOP assistance packet, the target UE may detect it.

On detecting the GDOP assistance packet, the target UE computes the TOA associated with the sidelink transmission (TOAsl) and signal to noise ratio (SNR) of the GDOP assistance packet using the header symbols, and decodes the GDOP data to retrieve the GDOP values for all TRP pairs in the GDOP assistance packet for which GDOP information is provided.

The target UE may use the calculated TOAsl to evaluate how far away the neighbour UE is from the target UE, and to decide how to use GDOP report.

For example, when TOAsl is less than a first threshold (i.e. TOAsl<Thr1), then target UE decodes the packet and uses the GDOP report of all TRP pairs. When Thr1 is less than a second threshold (i.e. TOAsl<Thr2), then target UE decodes the packet and uses only part of the GDOP report comprised therein. In other words, the target UE may determine to use the GDOP reports for the those TRP pairs with SNR conditions indicated as being good by the neighbour UE. These thresholds may be defined in a number of different ways. For example, at least one of the first and second thresholds may be specific to the target UE's current implementation. As another example, at least one of the first and second thresholds may be set by a network entity and/or defined by the 3GPP protocol. Signalling of the first and/or second thresholds may be performed via, for example, explicit signalling via LTE positioning protocol assistance data transmissions.

According to the presently disclosed techniques, a target UE may thus be enabled to acquire downlink positioning measurements for a small subset of relevant TRPs. The selection of the small subset of TRPs is enabled via SL assistance data sent by a neighbour UE. The SL signal contains information about the GDOP of any two TRPs, such as illustrated in Table 1.

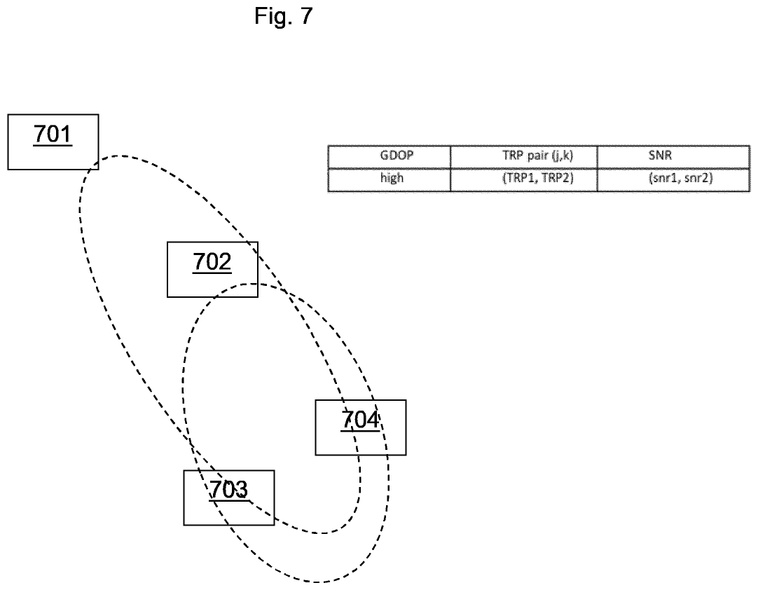

FIG. 7 is a schematic illustration of entities that may perform some of the operations described herein.

FIG. 7 shows a first TRP 701, a second TRP 702, a target UE 703, and a neighbour UE 704. Respective beams from the first and second TRPs are indicated by dashed lines. The first and second TRPs are seen as being collinear by the neighbour UE 704. A location service function in the network, such as an LMF in the core network, is not shown.

The target UE 703 is close to a neighbour UE 704 such that they are within range of each other for device-to-device/sidelink communication. The location service function may be aware of, or may be able to become aware of which UEs are close enough to each other to perform device-to-device/sidelink communications. The neighbour UE 704 has the capability to compute and report GDOP values of detected TRPs to the target UE 703 via device-to-device/sidelink communications.

Assuming a location service request arrives at the location service function for a target UE, the location service function determines a downlink positioning method for providing this request *e.g. downlink Time Difference of Arrival or downlink Angle of Departure). Alternatively, the target UE may compute its own location by measuring Radio Access Technology signals.

The location service function, which knows the relative location of the neighbour UE 704 to the target UE 703, triggers the neighbour UE to transmit a GDOP assistance packet information in response to this location service request. In the alternative example of the UE computing its own location, the UE may request the location service function to trigger transmission of the GDOP assistance packet from the neighbour UE 704 to the target UE 703.

As the first and second TRPs are seen as being collinear by the neighbour UE 704, the transmitted GDOP indicates that the GDOP of the first and second TRPs is high (i.e. that they are highly collinear). In other words, the transmitted packet may indicate GDOP (1, 2, neighbour)=high. This is shown in the table in FIG. 7, which shows potential fields of the GDOP packet for this TRP pair.

On receipt of the GDOP packet from the neighbour UE 704, the target UE 703 computes a Time of Arrival for the GDOP packet from the neighbour UE, and compares this computed value to a first threshold, Thr1. When the computed Time of arrival is less that the first threshold, this may indicate that the neighbour UE 704 is physically close enough to the target UE 703 that the target UE 703 may use the neighbour UE's GDOP values as its own, i.e. that the same GDOP values may apply equally. In the present case, this means that the target UE 703 assumes that GDOP (1, 2, neighbour)=high.

As a result of this assumption, the target UE 703 may choose to measure only one of the first and second TRPs in the high GDOP pair. The TRP selected for measurement by the target UE 703 may be selected in dependence on the indicated signal-to-noise ratio in the GDOP packet. In this present example, the signal-to-noise radio for the second TRP 702 is higher than the signal-to-noise ratio for the first TRP 701, and so the target UE 703 selects the second TRP to measure. The target UE 703 does not measure the other TRP in this case (i.e. the first TRP is not measured).

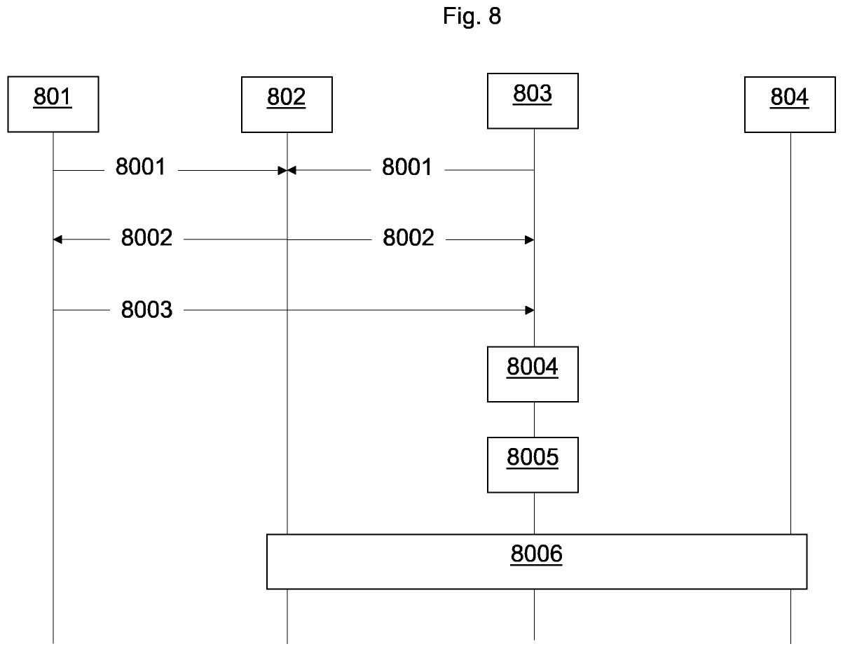

FIG. 8 illustrates potential signalling between elements discussed in this example of FIG. 7.

FIG. 8 shows signalling between a neighbour UE 801, a location service function 802, a target UE 803, and a TRP 804. It is understood that although some aspects of the following are shown as happening at the same time, this is not a constraint of the system, and they may instead be performed at different times.

At 8001, the neighbour UE 801 and the target UE 803 each send respective GDOP indications to the location service function 802. The GDOP indication indicates a capability of the neighbour UE for calculating GDOP information for TRPs. This GDOP indication may be provided to the location service function 802 in response to a trigger event, such as a request to provide the information to the location service function and/or a registration of the UE with the location service function 802. The UE 801/803 may send this GDOP indication when it is in a Radio Resource Control connected state with the radio access network. In the current example, the GDOP indication sent by the neighbour UE 801 indicates that the neighbour UE is capable of calculating GDOP information for TRPs, while the GDOP indication sent by the target UE 803 indicates that the target UE is not capable of calculating GDOP information for TRPs.

At 8002, the location service function 802 sends respective configuration information to the neighbour UE 801 and the target UE 803. This configuration information configures the neighbour UE 801 to send GDOP assistance information to the target UE 803, and configures the target UE 803 to receive GDOP assistance information from the neighbour UE 801. The respective configuration information may include, for example, a time-frequency allocation for the GDOP assistance information, a Modulation and Coding Scheme for the assistance information, etc.

At 8003, the neighbour UE 801 sends to the target UE 803 at least one computed GDOP for any two TRPs from a list of TRPs detected by the neighbour UE 801. This information may be sent via a device-to-device transmission. For example, this information may be sent via a sidelink transmission (i.e. direct transmission between the neighbour UE and the target UE). This GDOP assistance information may be broadcast over the sidelink transmission channel.

At 8004, the target UE 803 performs a time of arrival estimation for the GDOP assistance information. Using the time of arrival estimate, the target UE 803 evaluates how far away the neighbour UE 801 is from the target UE 803, and decides whether to decode the packet. When the time of arrival is small enough (i.e. below a predetermined threshold), then the target UE 801 considers it experiences similar channel conditions to neighbour UE, decodes the packet and performs steps 8005 and 8006 using the decoded information. Conversely, when the time of arrival is large (i.e. above the predetermined threshold), then the target UE 803 drops the packet.

At 8005, the target UE 803 determines a subset of TRP from the reported TRPs in the assistance information.

At 8006, the target UE 803, the location service function 802 and the TRP 804 exchange signalling to perform downlink positioning (as per a current positioning protocol, such as LTE positioning protocol).

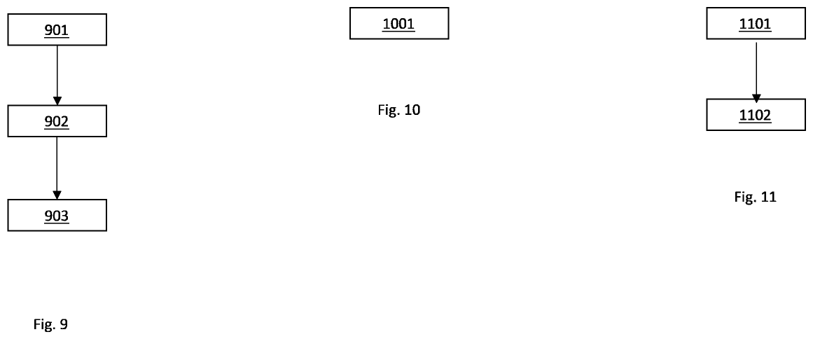

FIGS. 9 to 11 are flowcharts illustrating potential operations that may be performed by apparatus described herein.

FIG. 9 illustrates potential operations that may be performed by an apparatus for a first terminal. The first terminal may be, for example, a target UE, and may perform at least one of the operations described above in respect of the target UE.

At 901, the apparatus receives, from a second terminal, an indication of a degree of collinearity of at least two transmission points relative to the second terminal.

The second terminal may be a neighbour UE, such as described in relation to FIG. 10.

The indication of the degree of collinearity may be a degree of collinearity as assessed by the second terminal. The degree of collinearity may be determined by examining respective transmissions from the at least two transmission points, the respective transmissions indicating a directionality of an associated transmission point of the at least two transmission points. For example, the indication of the degree of collinearity may indicate that transmissions from the at least two transmission points are collinear to the second terminal (or at least within a threshold amount of collinearity, with the threshold amount being either defined by the second terminal or by a network entity).

For example, the apparatus may receive an indication that transmissions from at least two transmission points have a degree of collinearity that is within a defined/threshold amount. These thresholds may be as discussed herein. The indication may simply indicate that the at least two transmission points have transmissions that are within the second terminal's definition of collinearity. As another example, the indication may provide a numerical value indicating the degree of collinearity as determined by the second terminal.

The indication of the degree of collinearity may be sent directly from the second terminal to the first terminal (i.e. not via a radio access network entity). For example, the indication of collinearity may be sent using device-to-device signalling.

At 902, the apparatus selects a subset of the at least two transmission points using the indication of a degree of collinearity.

At 903, the apparatus performs a location operation using the selected subset of the at least two transmission points. The location operation may be, for example, a measurement usable (potentially with other measurements) for determining a location of the first terminal. The apparatus performs the location operation without using the unselected transmission points of the at least two transmission points. The unselected transmission points are those transmission points of the at least two transmission points that are not in the selected subset.

The apparatus may receive, from a network function, configuration information suitable for configuring reception of device-to-device signalling indicating the degree of collinearity of the at least two transmission points from the second terminal to the first terminal. The network function may be a location service function, such as described below in relation to FIG. 11. For example, the network function may be a location management function. This configuration information may be signalled to the apparatus through a radio access network. The apparatus may use the configuration information to configure the first terminal to receive the indication of a degree of collinearity.

The apparatus may receive an indication of a relative degree of signal quality for the at least two transmission points. The selecting of 903 may comprise using the indication of the relative degree of signal quality. The indication of the relative degree of signal quality may comprise indications of respective signal qualities for the at least two transmission points. For example, the relative degree of signal quality may be, for example, a ratio of signal-to-noise ratios (or similar) for the at least two transmission points.

The apparatus may transmit, to a network function, a request to trigger the second terminal to transmit the indication of the relative degree of signal quality. The network function may be a location service function, such as described below in relation to FIG. 11. For example, the network function may be a location management function.

FIG. 10 is a flow chart illustrating potential operations that may be performed by an apparatus for a second terminal. The second terminal may be, for example, a neighbour UE. The second terminal may perform at least one of the operations as described above in relation to the neighbour terminal.

At 1001, the apparatus transmits, to a first terminal, an indication of a degree of collinearity of at least two transmission points relative to the second terminal. The first terminal may be, for example, the first terminal described in relation to FIG. 9.

The indication of the degree of collinearity may be a degree of collinearity as assessed by the second terminal. The degree of collinearity may be determined by examining respective transmissions from the at least two transmission points, the respective transmissions indicating a directionality of an associated transmission point of the at least two transmission points. For example, the indication of the degree of collinearity may indicate that transmissions from the at least two transmission points are collinear to the second terminal (or at least within a threshold amount of collinearity, with the threshold amount being either defined by the second terminal or by a network entity).

For example, the apparatus may receive an indication that transmissions from at least two transmission points have a degree of collinearity that is within a defined/threshold amount. These thresholds may be as discussed herein. The indication may simply indicate that the at least two transmission points have transmissions that are within the second terminal's definition of collinearity. As another example, the indication may provide a numerical value indicating the degree of collinearity as determined by the second terminal.

The indication of the degree of collinearity may be sent directly from the second terminal to the first terminal (i.e. not via a radio access network entity). For example, the indication of collinearity may be sent using device-to-device signalling.

The second terminal may receive from a network function, configuration information suitable for configuring transmission of device-to-device signalling indicating a degree of collinearity between at least one transmission from at least two transmission points from the second terminal to the first terminal. The second terminal may use the configuration information to configure the second terminal to transmit the indication of a degree of collinearity.

The apparatus may transmit, to the first terminal an indication of a relative degree of signal quality for the at least two transmission points. The indication of the relative degree of signal quality may comprise indications of respective signal qualities for the at least two transmission points. For example, the relative degree of signal quality may be, for example, a ratio of signal-to-noise ratios (or similar) for the at least two transmission points.

FIG. 11 is a flow chart illustrating potential operations that may be performed by an apparatus for a network function. The network function may be a location service function. For example, the network function may be a location management function.

At 1101, in response to receiving a location service request for a first terminal, the apparatus selects a second terminal by: determining at least one terminal capable of both device-to-device communication with the first terminal and determining a degree of collinearity of at least two transmission points relative to the at least one terminal; and selecting the second terminal from the determined at least one terminal.

At 1102, the apparatus signals configuration information to at least one of the first and second terminals, the configuration information being suitable for configuring device-to-device signalling indicating a degree of collinearity of at least two transmission points relative to the second terminal from the second terminal to the first terminal.

The apparatus may receive, from the first terminal, a request to trigger the second terminal to transmit the indication of the relative degree of signal quality. This request may comprise the location service request.

The presently described techniques allow for a fast downselection of relevant TRP/TRP beams without exhaustive TRP transmit beam searching. Moreover, the present techniques are suitable for latency sensitive and/or low cost devices that do not have GDOP measurement capabilities.

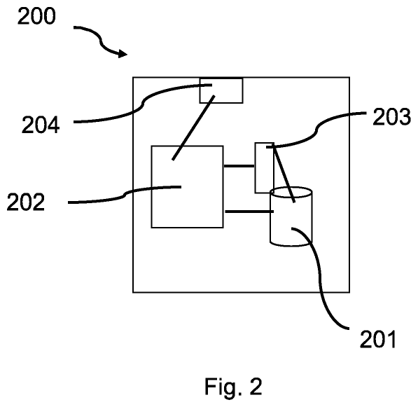

FIG. 2 shows an example of a control apparatus for a communication system, for example to be coupled to and/or for controlling a station of an access system, such as a RAN node, e.g. a base station, gNB, a central unit of a cloud architecture or a node of a core network such as an MME or S-GW, a scheduling entity such as a spectrum management entity, or a server or host, for example an apparatus hosting an NRF, NWDAF, AMF, SMF, UDM/UDR etc. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. The control apparatus 200 can be arranged to provide control on communications in the service area of the system. The apparatus 200 comprises at least one memory 201, at least one data processing unit 202, 203 and an input/output interface 204. Via the interface the control apparatus can be coupled to a receiver and a transmitter of the apparatus. The receiver and/or the transmitter may be implemented as a radio front end or a remote radio head. For example the control apparatus 200 or processor 201 can be configured to execute an appropriate software code to provide the control functions.

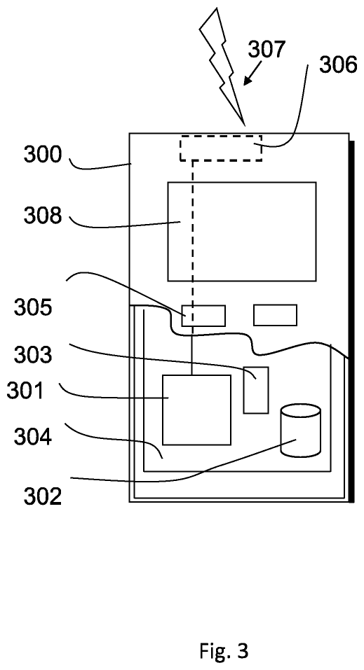

A possible wireless communication device will now be described in more detail with reference to FIG. 3 showing a schematic, partially sectioned view of a communication device 300. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

A wireless communication device may be for example a mobile device, that is, a device not fixed to a particular location, or it may be a stationary device. The wireless device may need human interaction for communication, or may not need human interaction for communication. In the present teachings the terms UE or “user” are used to refer to any type of wireless communication device.

The wireless device 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the wireless device.

A wireless device is typically provided with at least one data processing entity 301, at least one memory 302 and other possible components 303 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 704. The user may control the operation of the wireless device by means of a suitable user interface such as key pad 305, voice commands, touch sensitive screen or pad, combinations thereof or the like. A display 308, a speaker and a microphone can be also provided. Furthermore, a wireless communication device may comprise appropriate connectors (either wired or wireless) to other devices and/or for connecting external accessories, for example hands-free equipment, thereto.

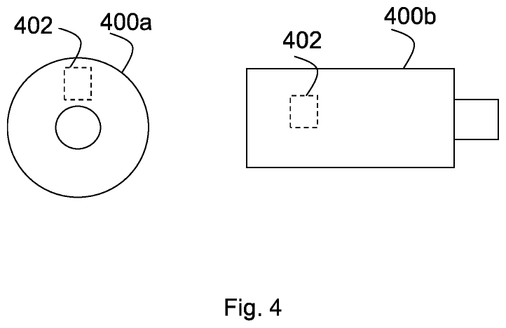

FIG. 4 shows a schematic representation of non-volatile memory media 400a (e.g. computer disc (CD) or digital versatile disc (DVD)) and 400b (e.g. universal serial bus (USB) memory stick) storing instructions and/or parameters 402 which when executed by a processor allow the processor to perform one or more of the steps of the methods of FIG. 9 and/or FIG. 10 and/or FIG. 11.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. Further in this regard it should be noted that any procedures, e.g., as in FIG. 9 and/or FIG. 10, and/or FIG. 11, may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (AStudy ItemC), gate level circuits and processors based on multi-core processor architecture, as non-limiting examples.

Alternatively or additionally some embodiments may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

In the above, different examples are described using, as an example of an access architecture to which the presently described techniques may be applied, a radio access architecture based on long term evolution advanced (LTE Advanced, LTE-A) or new radio (NR, 5G), without restricting the examples to such an architecture, however. The examples may also be applied to other kinds of communications networks having suitable means by adjusting parameters and procedures appropriately. Some examples of other options for suitable systems are the universal mobile telecommunications system (UMTS) radio access network (UTRAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

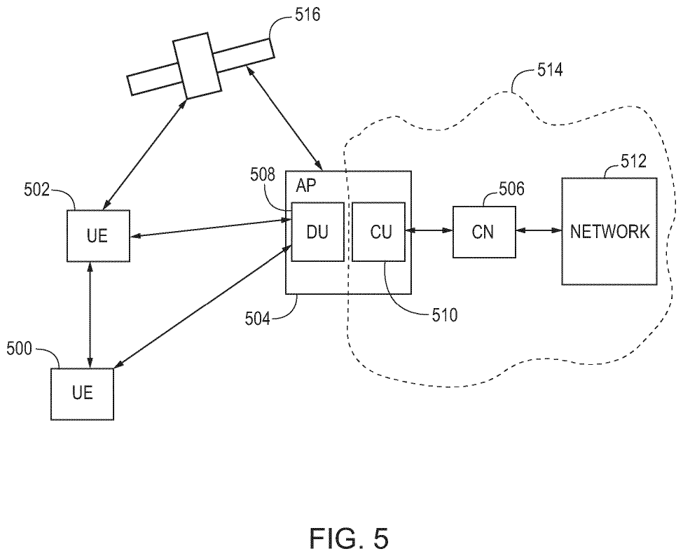

FIG. 5 depicts examples of simplified system architectures only showing some elements and functional entities, all being logical units, whose implementation may differ from what is shown. The connections shown in FIG. 5 are logical connections; the actual physical connections may be different. It is apparent to a person skilled in the art that the system typically comprises also other functions and structures than those shown in FIG. 5.

The examples are not, however, restricted to the system given as an example but a person skilled in the art may apply the solution to other communication systems provided with necessary properties.

The example of FIG. 5 shows a part of an exemplifying radio access network. For example, the radio access network may support device-to-device (e.g. sidelink) communications described below in more detail.

FIG. 5 shows devices 500 and 502. The devices 500 and 502 are configured to be in a wireless connection on one or more communication channels with a node 504. The node 504 is further connected to a core network 506. In one example, the node 504 may be an access node such as (e/g)NodeB serving devices in a cell. In one example, the node 504 may be a non-3GPP access node. The physical link from a device to a (e/g)NodeB is called uplink or reverse link and the physical link from the (e/g)NodeB to the device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to devices. The antenna unit may comprise a plurality of antennas or antenna elements. The (e/g)NodeB is further connected to the core network 506 (CN or next generation core NGC). Depending on the deployed technology, the (e/g)NodeB is connected to a serving and packet data network gateway (S-GW+P-GW) or user plane function (UPF), for routing and forwarding user data packets and for providing connectivity of devices to one or more external packet data networks, and to a mobile management entity (MME) or access mobility management function (AMF), for controlling access and mobility of the devices.

Examples of a device are a subscriber unit, a user device, a user equipment (UE), a user terminal, a terminal device, a mobile station, a mobile device, etc.

The device typically refers to a mobile or static device (e.g. a portable or non-portable computing device) that includes wireless mobile communication devices operating with or without an universal subscriber identification module (USIM), including, but not limited to, the following types of devices: mobile phone, smartphone, personal digital assistant (PDA), handset, device using a wireless modem (alarm or measurement device, etc.), laptop and/or touch screen computer, tablet, game console, notebook, and multimedia device. It should be appreciated that a device may also be a nearly exclusive uplink only device, of which an example is a camera or video camera loading images or video clips to a network. A device may also be a device having capability to operate in Internet of Things (IoT) network which is a scenario in which objects are provided with the ability to transfer data over a network without requiring human-to-human or human-to-computer interaction, e.g. to be used in smart power grids and connected vehicles. The device may also utilise cloud. In some applications, a device may comprise a user portable device with radio parts (such as a watch, earphones or eyeglasses) and the computation is carried out in the cloud.

The device illustrates one type of an apparatus to which resources on the air interface are allocated and assigned, and thus any feature described herein with a device may be implemented with a corresponding apparatus, such as a relay node. An example of such a relay node is a layer 3 relay (self-backhauling relay) towards the base station. The device (or, in some examples, a layer 3 relay node) is configured to perform one or more of user equipment functionalities.

Various techniques described herein may also be applied to a cyber-physical system (CPS) (a system of collaborating computational elements controlling physical entities). CPS may enable the implementation and exploitation of massive amounts of interconnected information and communications technology, ICT, devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 5) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control). 5G is expected to have multiple radio interfaces, e.g. below 6 GHz or above 24 GHZ, cmWave and mmWave, and also being integrable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHZ-cmWave, 6 or above 24 GHz-cmWave and mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 512, such as a public switched telephone network, or a VoIP network, or the Internet, or a private network, or utilize services provided by them. The communication network may also be able to support the usage of cloud services, for example at least part of core network operations may be carried out as a cloud service (this is depicted in FIG. 5 by “cloud” 514). The communication system may also comprise a central control entity, or a like, providing facilities for networks of different operators to cooperate for example in spectrum sharing.

The technology of Edge cloud may be brought into a radio access network (RAN) by utilizing network function virtualization (NFV) and software defined networking (SDN). Using the technology of edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at or close to a remote antenna site (in a distributed unit, DU 508) and non-real time functions being carried out in a centralized manner (in a centralized unit, CU 510).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, Mobile Broadband, (MBB) or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 5 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 5). A HNB Gateway (HNB-GW), which is typically installed within an operator's network may aggregate traffic from a large number of HNBs back to a core network.

1. An apparatus for a first terminal, the apparatus comprising:
at least one processor; and
at least one memory comprising computer code that, when executed by the at least one processor, causes the apparatus to:
receive, from a second terminal, an indication of a degree of collinearity of at least two transmission points relative to a location of the second terminal;
select a subset of the at least two transmission points using the indication of a degree of collinearity; and
perform a location operation using the selected subset of the at least two transmission points.

2. An apparatus as claimed in claim 1, wherein the apparatus is caused to:
receive, from a network function, configuration information suitable for configuring reception of device-to-device signalling indicating the degree of collinearity from the second terminal at the first terminal; and
use the configuration information to configure the first terminal to receive the indication of a degree of collinearity.

3. An apparatus as claimed in claim 1, wherein the apparatus is caused to:
receive an indication of a relative degree of signal quality for the at least two transmission points; and
wherein the selecting comprises using the indication of the relative degree of signal quality.

4. An apparatus as claimed in claim 3, wherein the indication of the relative degree of signal quality comprises indications of respective signal qualities for the at least two transmission points.

5. An apparatus as claimed in claim 1, wherein the apparatus is caused to transmit, to a network function, a request to trigger the second terminal to transmit the indication of the relative degree of signal quality.

6. An apparatus for a second terminal, the apparatus comprising:
at least one processor; and
at least one memory comprising computer code that, when executed by the at least one processor, causes the apparatus to:
transmit, to a first terminal, an indication of a degree of collinearity of at least two transmission points relative to a location of the second terminal.

7. An apparatus as claimed in claim 6, wherein the apparatus is caused to:
receive, from a network function, configuration information suitable for configuring transmission of device-to-device signalling indicating the degree of collinearity of at least two transmission points from the second terminal to the first terminal; and
use the configuration information to configure the second terminal to transmit the indication of the degree of collinearity.

8. An apparatus as claimed in claim 6, wherein the apparatus is caused to:
transmit to the first terminal an indication of a relative degree of signal quality for the at least two transmission points.

9. An apparatus as claimed in claim 8, wherein the indication of the relative degree of signal quality comprises indications of respective signal qualities for the at least two transmission points.

10. An apparatus for a network function, the apparatus comprising:
at least one processor; and
at least one memory comprising computer code that, when executed by the at least one processor, causes the apparatus to:
select, in response to receiving a location service request for a first terminal, a second terminal by:
determining at least one terminal capable of both device-to-device communication with the first terminal and determining a degree of collinearity of at least two transmission points relative to the said at least one terminal; and
selecting the second terminal from the determined at least one terminal; and
signal configuration information to at least one of the first and second terminals, the configuration information being suitable for configuring device-to-device signalling indicating a degree of collinearity of at least two transmission points relative to the second terminal from the second terminal to the first terminal.

11. An apparatus as claimed in claim 10, wherein the apparatus is caused to receive, from the first terminal, a request to trigger the second terminal to transmit the indication of the relative degree of signal quality.

12-17. (canceled)
